(19) United States
(12) Patent Application Publication
(10) Pub. No.: US 2003/0178100 A1
(43) Pub. Date: Sep. 25, 2003

(54) Teak board with straight-line grain and manufacturing process therefor

(76) Inventor: Wutipong Chaisang, Meung (TH)

Correspondence Address: Edward Gray, P.O. Box 66629, Mar Vista, CA, 90066-0629, US

(21) Appl. No.: 10/105,638

(22) Filed: Mar. 23, 2002

(51) Int. Cl. B27D 1/00; B27G 11/00

(52) U.S. Cl. 144/346

(57) ABSTRACT

Five methods of cutting teak wood timber so that the resulting logs have straight-line grain surfaces and minimal surface area showing buds. Logs or sections thereof when aligned and glued together form boards with straight-line grain surfaces.

### BACKGROUND OF THE INVENTION

1. Field of the Invention

This invention relates to the manufacturing of wood boards, and more particularly to using teak heartwood and teak sapwood for making wood boards having surfaces with straight-line grain.

2. Description of the Related Art

Teakwood is a precious wood, which nowadays is rare in natural forest. So it's seriously required to be protected by law and controlled for cultivating and deforesting. Anyway the good quality of cultivate teak plant must have aged for over decades year. The side of the plant must be big so that it will consist of more part of wood grain, which color is brown and the brown grain should be transformed to be wood board with composed of good quality of beautiful grain line with anti-termites and anti-fungi.

Formerly, the production process of wood transformation is to cut out all part of sapwood which color is white because fungi will damage this part later and it is a belief that the sapwood part is not useful in common. And the transformation of small side of teak plant will show a lot of bud which is not favor and it will be considered to be low quality and grade, as shown in FIGS. 19, 20 and 21.

### SUMMARY OF THE INVENTION

The objective of the invention is to develop teakwood and teak sapwood which color is white to be more useful and value added to make the board which has a quality as good as real teakwood board with a beautiful grain. It is suitable for furnishing all kinds of decoration and furniture, especially for the benefit of cultivated teak plantation. Mostly, the cultivated teakwood has a relatively small side diameter and has a lot of sapwood part which in command is low quality and glade and used for flammable material or cheap wall partition only.

### BRIEF DESCRIPTION OF THE DRAWINGS

FIG. 1 shows a cross-sectional view of teak timber out of bud area.

FIG. 2 shows teak timber which has opposite bud along the length of timber.

FIG. 3 shows a cross-sectional view of teak timber showing the opposite bud area along the length of plant which will have two opposite sides and make a right angle to each other.

FIG. 4 shows four sections having straight-line grain when the timber is cut across the annual ring.

FIG. 5 shows a first embodiment according to the invention, the dotted line depicting where the timber is cut in order to have one side with straight-line grain and another showing bud shape interval.

FIG. 6 shows logs cut according to FIG. 5.

FIG. 7 shows a FIG. 6 square log having straight-line grain along its length.

FIG. 8 shows the FIG. 6 logs with one side of each log smoothed and contiguously glued to form a one-piece board having straight-line grain in front.

FIG. 9 shows a second embodiment, the dotted line depicting a cutting line that creates straight-line grain on one side of each log and bud line on the opposed side.

FIG. 10 shows square logs cut according to FIG. 9.

FIG. 11 shows the FIG. 10 square logs each smoothed on one side before being aligned parallel and contiguously glued to form a wide board

FIG. 12 shows a third embodiment, the dotted line depicting a cutting line that eliminates bud area and creates straight-line grain on both sides of each FIG. 10 log.

FIG. 13 shows the FIG. 10 square logs contiguously glued so that the bud shape is not shown on either side.

FIG. 14 shows a fourth embodiment wherein triangular pieces cut from the FIG. 12 logs can be used to make small planks or be contiguously glued to form a wide board.

FIG. 15 shows a fifth embodiment wherein timber is cut so as to produce logs having two sides with straight-line grain.

FIG. 16 shows timber cut according to the FIG. 15 embodiment.

FIG. 17 shows a thin board produced by cutting and gluing according to the method of FIGS. 15, 16.

FIG. 18 shows a teak board strengthened by gluing a low quality board underneath the teak board.

FIG. 19 shows the traditional cutting method which does not eliminate or even mitigate bad bud shape.

FIG. 20 shows a log cut according to the FIG. 19 method.

FIG. 21 shows a board produced by cutting according to the FIGS. 19, 20 method, resulting in bad bud shape and absence of straight-line grain.

### DESCRIPTION OF THE PREFERRED EMBODIMENTS

While the present invention is open to various modifications and alternative constructions, the preferred embodiments shown in the drawings will be described herein in detail. It is to be understood, however, there is no intention to limit the invention to the particular forms disclosed. On the contrary, it is intended that the invention cover all modifications, equivalences and alternative constructions falling within the spirit and scope of the invention as expressed in the appended claims.

A more complete understanding of the present invention and other objects, aspects and advantages thereof will be gained from a consideration of the following description of the preferred embodiments read in conjunction with the accompanying drawings.

The invention of straight-line grain teakwood board production is the process of cutting teakwood in the section of straight line grain and not in bud section. The chemical threat for protecting of termites, insects and fungi, is required. Then go to dry up and try to arrange the beautiful line grain in sequence and then glue and paste to be a big piece board which capable of transforming to be as large as required with specific line grain which is the main benefit of the industry. In which we can use the small side of teak plant to transform to be big teak board and value added for useless sapwood part.

The production of teak board in this invention consists of process of

1. cutting teak plant to be a timber;

2. cutting the timber in vertical and will cut the bud section and annual ring out; and

3. lining up the straight-line grain piece board in the same direction and parallel and finally glue and paste to be a big board.

The teak plantation used for this invention should be 4 years old at least and may be cultivated plant by tissue culture method or in natural plantation.

The production process of this invention may be modified by cutting teak timber in vertical direction in square shape and line the square timbers in the same direction and smoothening the pieces timber at least one side and may color the board in any color as required.

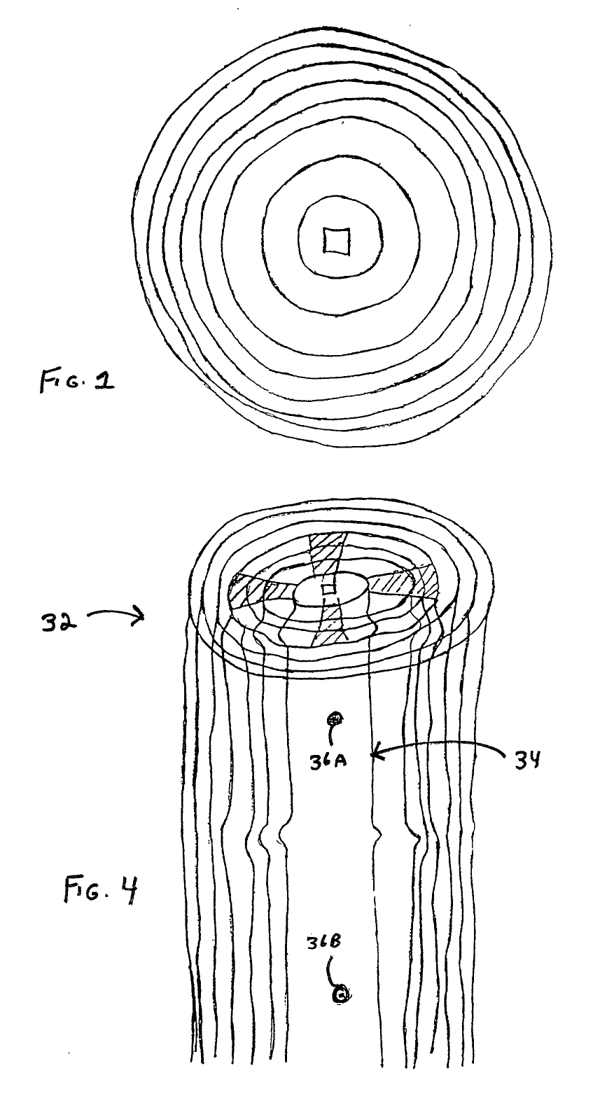

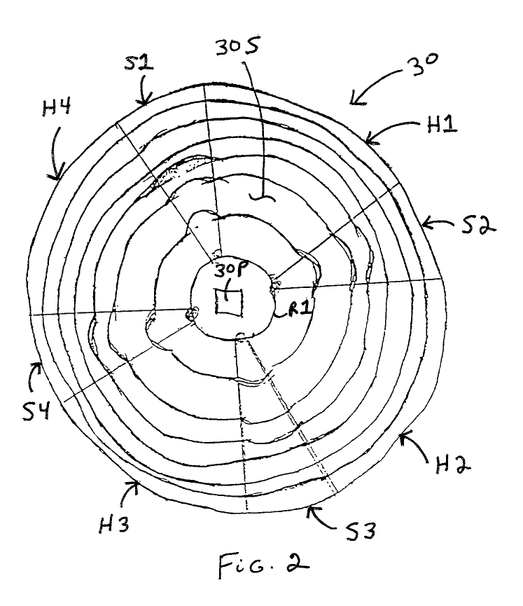

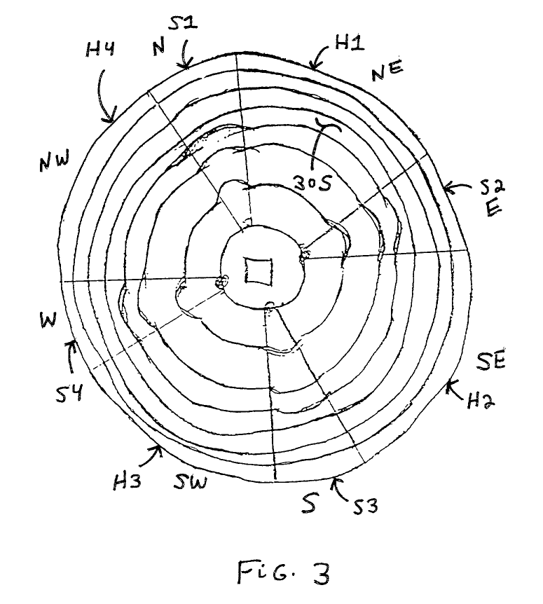

Generally, if the teak plant is horizontal cut to be timber and it shows the annual ring if the cutting section is not in the bud cross section area, as shown in FIG. 1. In fact, the teak plant have two opposite sides of bud along the length of plant. And every year the teak plant is growing up and creates one annual ring each year. And the new created grain will cover round the plant and the bud also and then cause the miss shape of grain in the bud part which mean that there will be two opposite sides miss shape of grain (as shown in FIGS. 2 and 3).

Embodiment 1

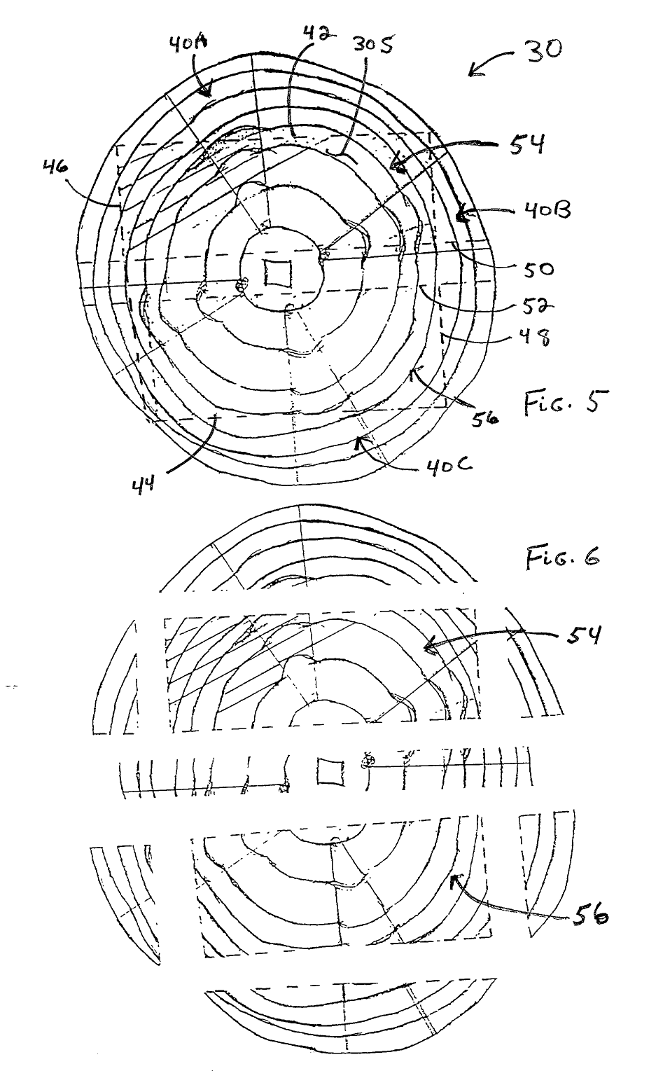

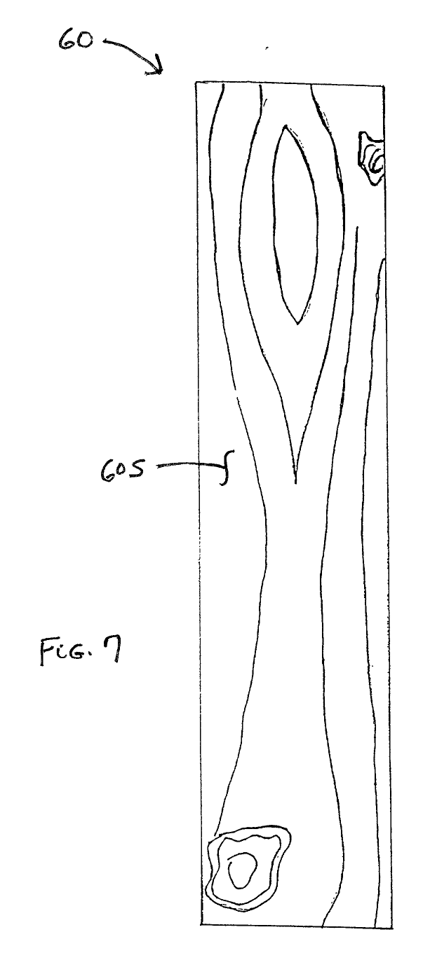

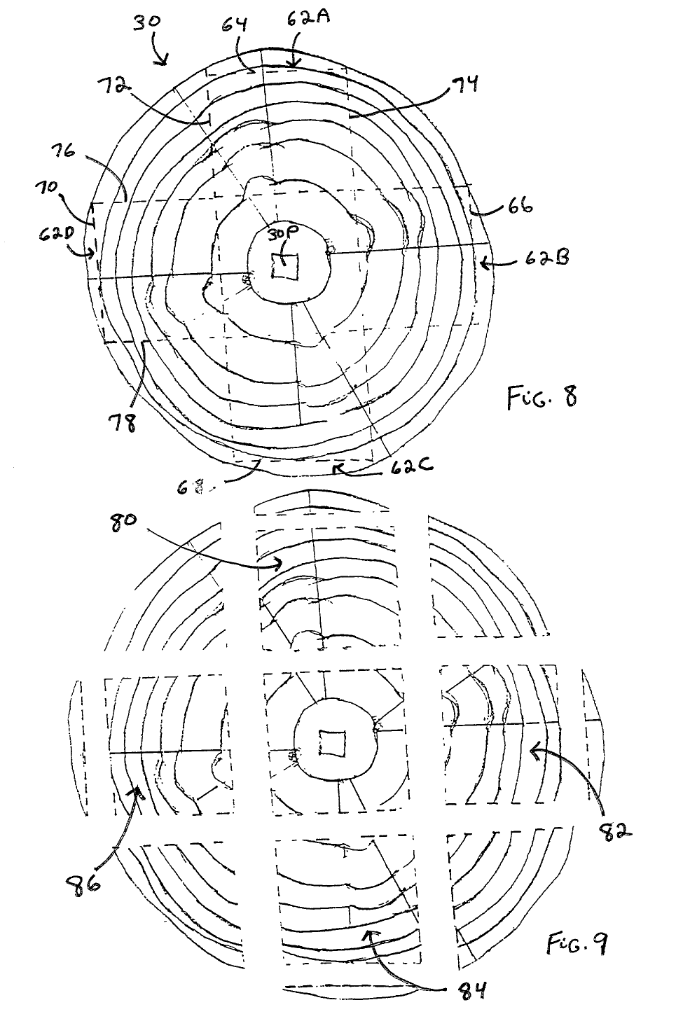

As shown in FIG. 5, the dotted line shows a cutting line so that there will be four square logs of timber with one side of eacj log showing no bud line as follows 1 2 3 4 (FIG. 6). FIG. 7 shows a square log cut according to the method of FIGS. 5, 6. First, one side of each log is smoothed and the logs are then aligned parallel and glued together so that the straight-line grain always appears on the front face and the bud line is opposite to the area (as shown in FIG. 8).

Embodiment 2

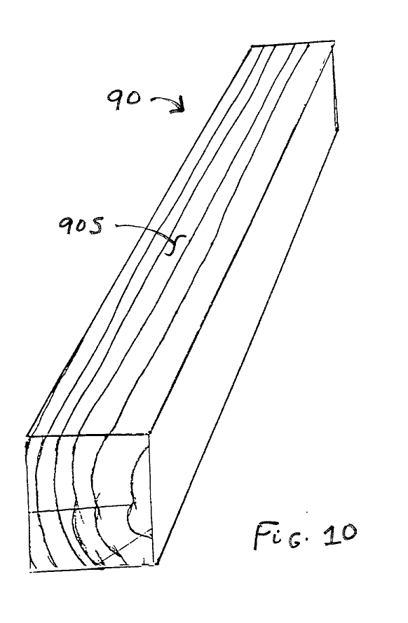

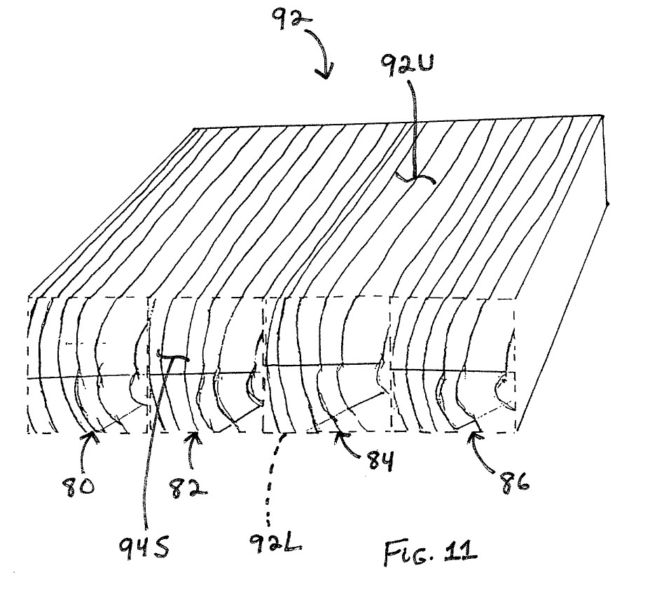

Referring to FIG. 9, in a second embodiment timber is cut along a dotted line so that square logs are produced wherein one side of the timber is not in the bud side area. As shown in FIG. 10, what is different from the first embodiment is that the cutting line now cuts through the annual ring and makes a right angle with the center annual ring, resulting in four square logs. The logs are then contiguously aligned so that the straight-line grain faces out and the bud area is opposed, and then glued together to form a board.

Embodiment 3

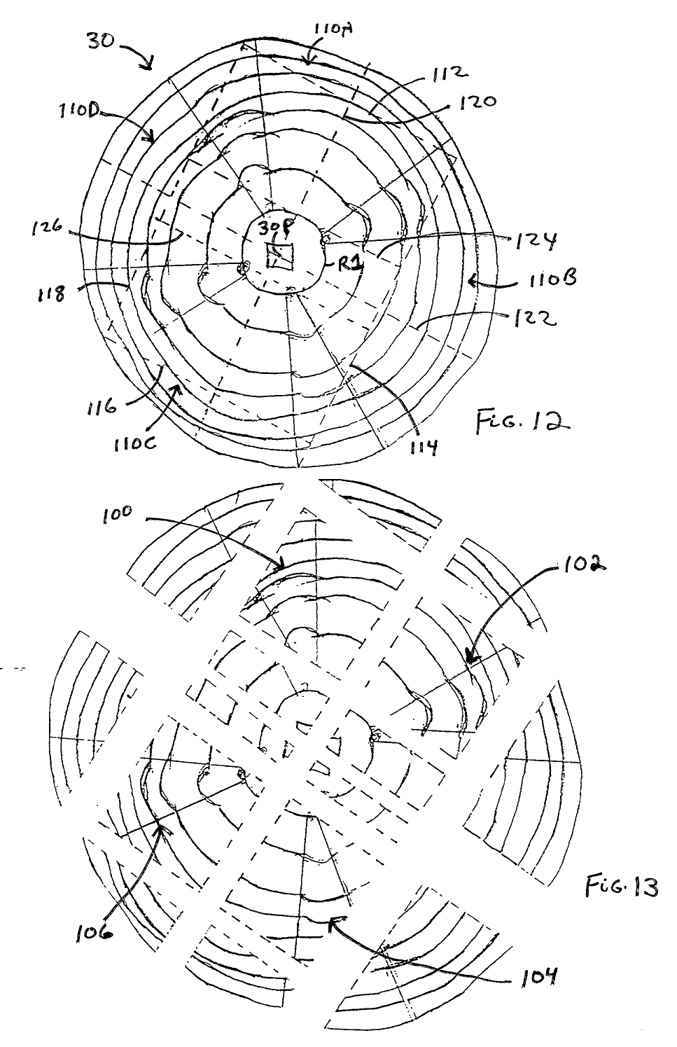

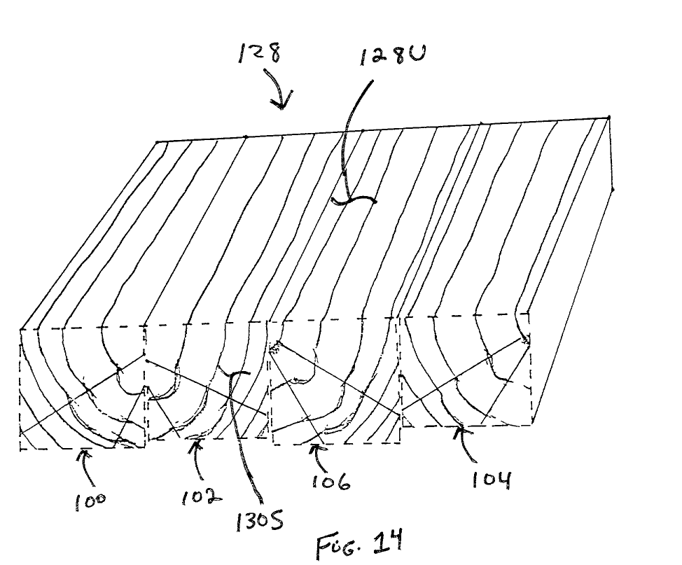

FIG. 12 shows a third embodiment wherein the cutting line (depicted by the dotted line) avoids the bud area. The bud area is now inside each square log and so is not visible. As shown in FIG. 13, the logs are aligned and glued together to form a wood board.

Embodiment 4

As shown in FIG. 14, in a fourth embodiment cutting logs produced according to the third embodiment can be cut into triangular pieces which can then be glued together to form a small plank or a wide board having straight-line grain.

Embodiment 5

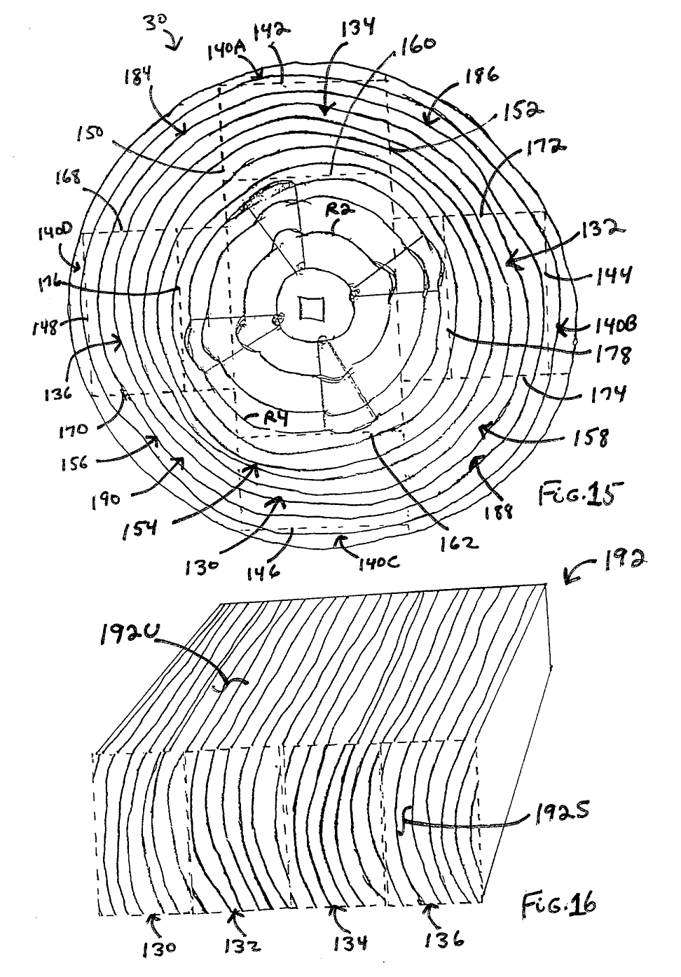

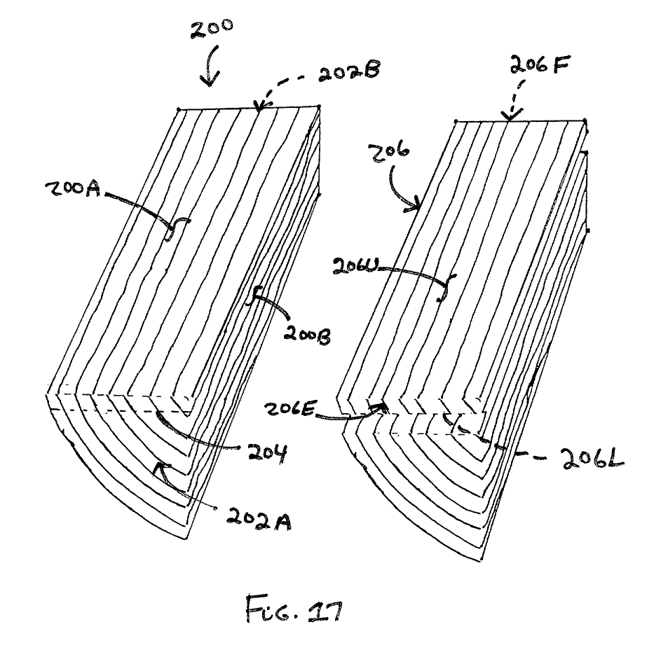

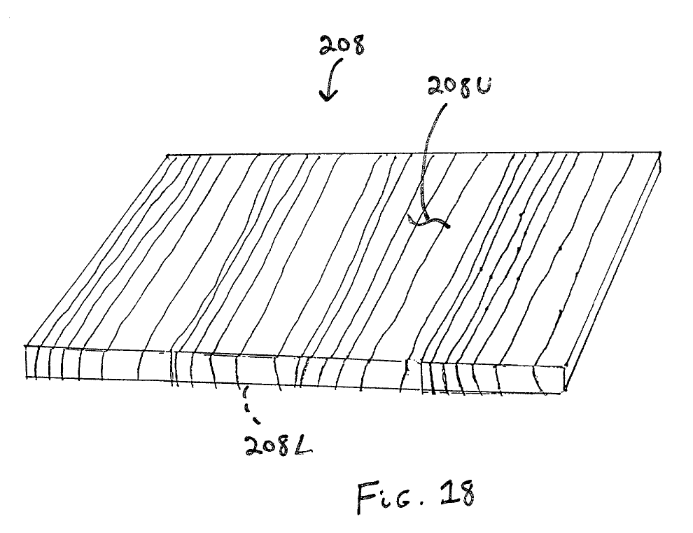

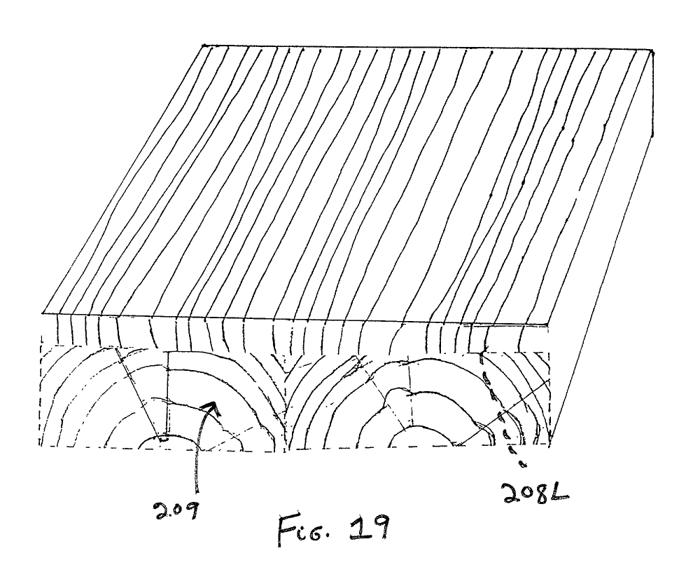

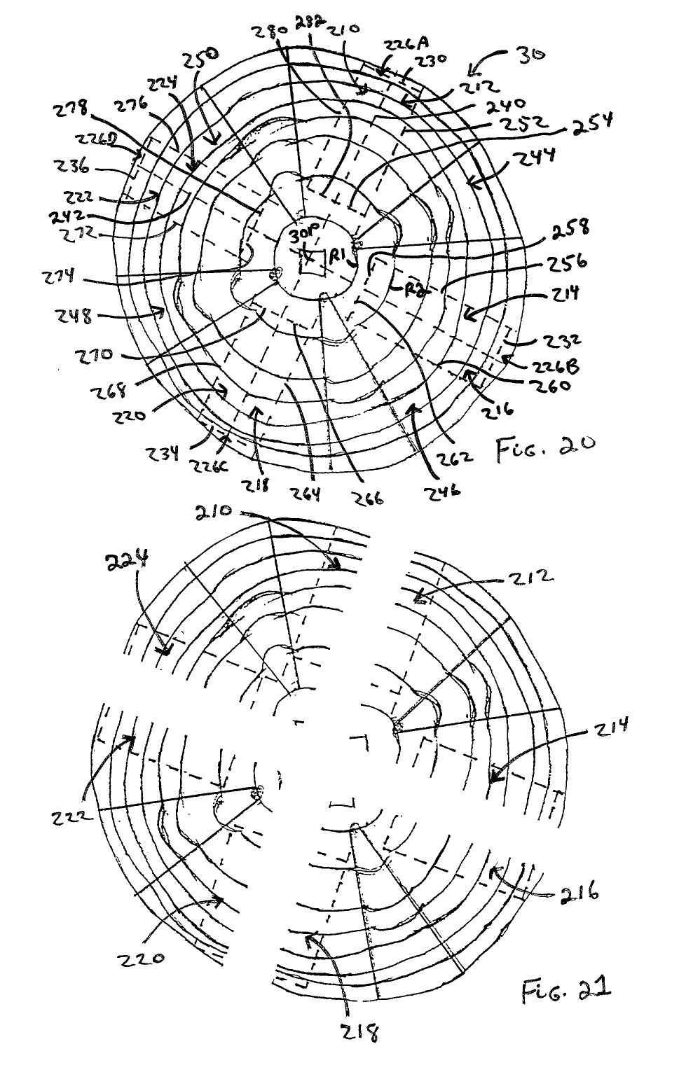

As shown in FIG. 15, in a fifth embodiment timber is cut into small planks which have two sides with straight-line grain. FIG. 16 shows timber cut according to the FIG. 15 method. As shown in FIG. 17, the planks can be glued together to form a thin board. As shown in FIG. 18, the board can be thickened by gluing a second board underneath the board.

The boards produced according to the five embodiments must be chemically treated to protect against termites, insects and fungi. If the color of the timber sections is not brown, they must be dried before gluing to form boards can proceed.

What is claimed is:

1. The process of manufacturing a straight-line grain teak board comprising the steps of:
a) cutting teak timber across the annual ring and along the length of timber at side in which is not at bud appearing;
b) lining up the straight-line grain plank from step (a) in the way that all planks show the same side and parallel the straight-line grain; and
c) gluing and paste all obtained planks from step (b) to be big board.

2. The process according to claim 1 wherein may further include the step of smoothening plane timber to be square planks along the length of timber prior to step (b).

3. The process according to claim 2 wherein at least one side of plank is planed to have the straight line grain parallel to the length of the plank.

4. The process according to any of claims 1-3 further comprising the step of coloring the grain board.

5. The process according to any of claims 1-4 in which the timbers should be over 4 years old teak plant.

6. The straight-line grain teak board which is made from the process according to any of claims 1-5.

7. The straight-line grain teak board according to claim 6 which is in a form of plank or board.

8. Use of the product according to any of claims 1-5 wherein the product can be used in household or other industry.
